(19) United States
(12) Patent Application Publication
(10) Pub. No.: US 2025/0052107 A1
(43) Pub. Date: Feb. 13, 2025

(54) GLAZING BAR AND ASSEMBLY

(71) Applicant: Clement Windows Group Limited, Haslemere (GB)

(72) Inventor: Antony Holden, Haslemere (GB)

(21) Appl. No.: 18/723,580

(22) PCT Filed: Dec. 21, 2022
(86) PCT No.: PCT/GB2022/053335

§ 371 Date: Jun. 24, 2024

(30) Foreign Application Priority Data
Dec. 24, 2021 (GB) 2119018.6

(51) Int. Cl. E06B 3/68

(52) U.S. Cl. CPC E06B 3/685

(57) ABSTRACT

For use in a window (10) that comprises a glazing unit (12) with at least one pane of glass, an assembly comprises a glazing bead (14) to extend around the periphery of the glazing unit (12) and defining apertures (17) at locations at which a glazing bar (16) is to fit, and at least one glazing bar (16) to extend across a face of the glazing unit (12), at least one end of the glazing bar (16) comprising a spring-loaded pin (20) to engage with an aperture (17) in the glazing bead (14). For example each glazing bar (16) may comprise spring-loaded pins (20) at each end, or alternatively a spring-loaded pin (20) at one end and a fixed projecting pin at the other end.

The present invention relates to a glazing bar for a window, suitable for use in a single-double- or triple-glazed window, and to an assembly that includes a glazing bar and a glazing bead.

Single-glazed steel windows, that is to say single-glazed windows with steel frames and bars, were commonly used from the late nineteenth century to the late twentieth century. Such windows can provide the benefits of increased light transmission, because as compared to a wooden frame less of the window space is obstructed by the frame itself; and these windows often match the architectural style of the building in which they are installed. However when considering heat loss from a building, such windows are disadvantageous because they are single-glazed and because the steel frame itself is a good heat conductor. So where it is necessary to replace such steel windows, or where for other architectural reasons a steel window frame is desired, a more modern design of steel window may be used that can accommodate double-glazed or triple-glazed panes, and where the frame itself is designed to minimize heat conduction, but may be designed to closely resemble an earlier design of steel window.

Where a window with a single double-glazed pane is required to have the appearance of multiple smaller panes separated by glazing bars (which may be referred to as muntin bars), this may be achieved by mounting thin bars between the two sheets of glass that form the double-glazed pane; this may look satisfactory from a distance, but inevitably differs in appearance from a glazing bar, as a glazing bar projects outside the outer surface of the glass. An alternative solution is to bond a bar or strip to the outer surface of the glass, for example with double-sided adhesive tape, the bar or strip having a longitudinal profile corresponding to the projecting part of the desired glazing bar. This provides a satisfactory solution as regards the external appearance of the window, but there is a risk that the adhesive may fail.

According to a first aspect of the present invention there is provided an assembly for use with a window that comprises a glazing unit with at least one pane of glass, the assembly comprising a glazing bead to extend around the periphery of the glazing unit, the glazing bead defining apertures at locations at which a glazing bar is to fit, and at least one glazing bar to extend across a face of the glazing unit, at least one end of the glazing bar comprising a spring-loaded pin to engage with an aperture in the glazing bead, each aperture extending parallel to the face of the glazing unit, and the spring-loaded pin being movable along an axis parallel to the face of the glazing unit to locate in the aperture.

The pin defines a projecting portion whose surfaces extend parallel to the axis and that locates within the aperture, so a wall defining the aperture engages a surface of the pin that extends parallel to the axis. Because the pins and the apertures extend parallel to the face of the glazing unit, the glazing bar is held securely to the glazing bead, so it cannot fall off even if pulled away from the glazing unit.

For example the window may include a double-glazed or a triple-glazed glazing unit; and the window may include a steel frame or a frame of another material such as wood or a rigid plastic.

Each glazing bar may comprise spring-loaded pins at each end, or may comprise a fixed projecting pin at one end with the spring-loaded pin at the other end, each pin projecting parallel to the face of the glazing unit.

Each glazing bar may in addition be adhered to the face of the glazing unit, for example by double-sided adhesive tape.

The glazing bead may have an outer face that slopes at an acute angle away from the face of the glazing pane. The glazing bar may also define outer faces that slope at an acute angle away from the face of the glazing pane. The glazing bead may be of a rigid plastic or of a metal such as aluminium, and may be formed by extrusion. The glazing bar may also be of a rigid plastic or of a metal such as aluminium, and may be formed by extrusion.

In a second aspect, the invention provides a glazing bar for use in such an assembly, the glazing bar comprising a spring-loaded pin at at least one end.

The invention will now be further and more particularly described, by way of example only, and with reference to the accompanying drawings in which:

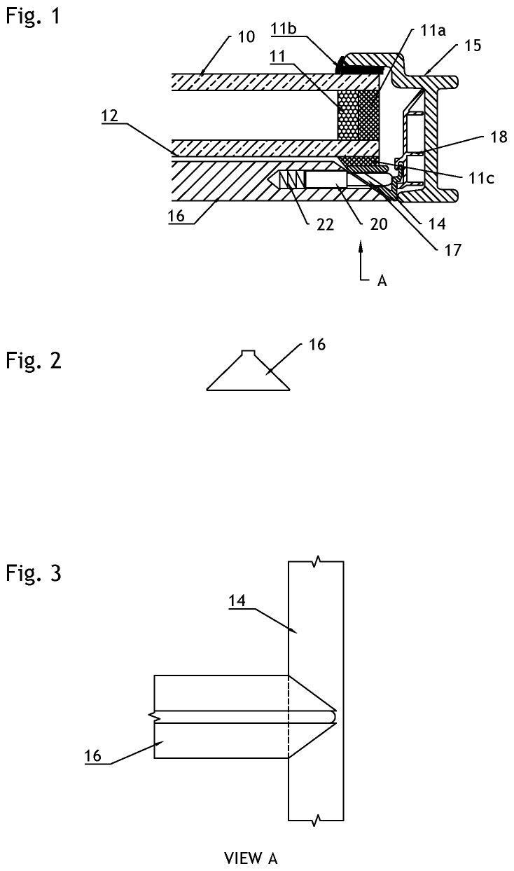

FIG. 1 shows a cross-sectional view of a glazing bar of the invention attached to a glazing bead of a window, shown in part;

FIG. 2 shows a longitudinal view of the profile of the glazing bar; and

FIG. 3 shows a plan view in the direction of arrow A of FIG. 1.

Referring to FIG. 1, a window 10 includes a double-glazed unit 12 held by a glazing bead 14 around its periphery into a steel frame 15. The frame 15 is of roughly I-shaped cross-section, with inner and outer bars connected by a thin web to minimize the cross-sectional area for heat transfer. The inner face of the double-glazed unit 12 is up against a peripheral flange of the steel frame 15, while the glazing bead 14 is held against the outer face of the double-glazed unit 12 by clips 18 that are fixed to the frame 15 for example by screws (not shown).

The sheets of glass that form the double-glazed unit 12 are held apart by a peripheral spacer 11 provided with a surrounding sealant 11a. A gasket 11b is adhered to the inner face of the double-glazed unit 12 and seals to the peripheral flange of the steel frame 15. A glazing tape 11c seals between the outer face of the double-glazed unit 12 and the glazing bead 14. The spacer 11 and the sealing components 11a, 11b and 11c are conventional.

A glazing bar 16 extends across the outer face of the double-glazed unit 12; it may be adhered to the face of the double-glazed unit 12, for example by double-sided adhesive tape (not shown). Referring also to FIG. 2, the glazing bar 16 has a broad base adjacent to the face of the double-glazed unit 12 and it tapers to a central ridge, so the sides slope at an acute angle away from the face of the double-glazed unit. The glazing bead 14, as shown in FIG. 1, is of generally triangular cross-sectional shape, so its outer, exposed face also slopes at an acute angle away from the face of the double-glazed unit 12. The end of the glazing bar 16 is cut off at the same angle as the sloping face of the glazing bead 14, so as shown also in FIG. 3 the end part of the glazing bar 16 fits over the glazing bead 14.

Referring again to FIG. 1, at the location where the glazing bar 16 is to be fitted, an aperture 17 (shown in broken lines) is formed in the glazing bead 14, the aperture extending in a direction parallel to the face of the double-glazed unit 12. A cylindrical channel is defined in the end of the glazing bar 16 and locates a steel pin 20 which is pushed out by a spring 22; the pin 20 is thus spring-loaded to project out (as shown) but the channel is such that the pin 20 can be pushed right in so it doesn't protrude. The pin 20 has a part that can slide in the channel, and a somewhat thinner part that can project out (as shown). During manufacture, the cylindrical channel may be drilled, the spring 22 and the pin 20 may then be inserted, and the open end of the channel peened over to form a lip, so the pin 20 can't fall out.

During assembly of the window 10, the pin 20 can be pushed in for example with a stiff thin blade, and the glazing bar 16 brought up to the face of the double-glazed unit 12 until the tip of the pin 20 is next to the sloping face of the glazing bead 14. The blade can be removed, so the tip of the pin 20 rests against that sloping face, and as the glazing bar 16 is pushed further towards the double-glazed unit 12 the pin 20 comes into alignment with the aperture 17, and springs out into the aperture 17, into the position as shown, so securing the glazing bar 16 in position. The tip of the pin 20 is rounded, but the remainder of the projecting part of the pin 20 is cylindrical, so in the position as shown the wall of the aperture 17 is up against the cylindrical part of the pin 20. Any outward force on the glazing bar 16 merely pulls the side of the pin 20 firmly against the wall of the aperture 17.

The other end of the glazing bar 16 may either have a spring-loaded pin 20, as described, or may instead have a fixed projecting pin. If it is a fixed pin, then the end with the fixed pin must be fitted first, ensuring the fixed pin fits into the corresponding aperture 17; and then the end with the spring-loaded pin 20 would be assembled exactly as described above. If there are spring-loaded pins 20 at each end, then it doesn't matter which end is brought into engagement with the glazing bead 14 first.

1: An assembly for use with a window that comprises a glazing unit with at least one pane of glass, the assembly comprising a glazing bead to extend around the periphery of the glazing unit, the glazing bead defining apertures at locations at which a glazing bar is to fit, and at least one glazing bar to extend across a face of the glazing unit, at least one end of the glazing bar comprising a spring-loaded pin to engage with an aperture in the glazing bead, each aperture extending parallel to the face of the glazing unit, and the spring-loaded pin being movable along a line parallel to the face of the glazing unit to locate in the aperture, the glazing bar held securely such that it cannot fall off even if pulled away from the glazing unit.

2: An assembly as claimed in claim 1 wherein each glazing bar comprises spring-loaded pins at each end.

3: An assembly as claimed in claim 1 wherein each glazing bar comprises a fixed projecting pin at one end with the spring-loaded pin at the other end.

4: An assembly as claimed in claim 1 also comprising adhesive to adhere each glazing bar to the face of the glazing unit.

5: An assembly as claimed in claim 4 wherein the adhesive is in the form of double-sided adhesive tape.

6: An assembly as claimed in claim 1 wherein the glazing bead has an outer face that slopes at an acute angle away from the face of the glazing unit, and the glazing bar also defines at least one outer face that slopes at an acute angle away from the face of the glazing unit.

7: An assembly as claimed in claim 1 wherein the glazing bead is of a rigid plastic or of a metal such as aluminium.

8: An assembly as claimed in claim 7 wherein the glazing bead is formed by extrusion.

9: An assembly as claimed in claim 1 wherein the glazing bar is of a rigid plastic or of a metal such as aluminium.

10: An assembly as claimed in claim 9 wherein the glazing bar is formed by extrusion.

11: A glazing bar for use in an assembly as claimed in claim 1, the glazing bar comprising a spring-loaded pin at at least one end.
